(19) United States
(12) Patent Application Publication
(10) Pub. No.: US 2021/0154099 A1
(43) Pub. Date: May 27, 2021

(54) TOP LIQUID FILL METHOD AND APPARATUS FOR HARD CAPSULES

(71) Applicants: Karl Wei CAO, Vancouver (CA); Hu CAO, Taiyun (CN)

(72) Inventors: Karl Wei CAO, Vancouver (CA); Hu CAO, Taiyun (CN)

(21) Appl. No.: 16/691,986

(22) Filed: Nov. 22, 2019

(51) Int. Cl. A61J 3/07

(52) U.S. Cl. CPC A61J 3/074; A61J 2200/76; A61J 3/072

(57) ABSTRACT

A method of filling two piece hard shell capsules from top through opening on the center of domes of fused hard shell—FETH capsules, rather than open the “prelock” capsules and filling liquid into the body part of the hard shell capsules. The novel method will (i) significantly reduce the size of air bubbles, (ii) eliminate need for post filling banding or sealing, (iii) able to use any type of two piece hard shell capsules, eliminate the need for specially designed liquid fill friendly capsule and (iv) streamlined the traditional liquid filling process and make it into one continuous process. The capsules filled by the new methods hold 10-15% more liquid and become more competitive to soft gel capsules in terms of costs and efficiency.

### FIELD

Embodiments of the disclosure generally relate to method, process and apparatus for filling solvent soluble or hydrophobic liquid, semi liquid and paste into two piece hard shell capsules made of any film forming material for oral dosage of pharmaceuticals, vitamins and food products.

### BACKGROUND AND PRIOR ART

The traditional process for filling solvent soluble or hydrophobic liquid into two piece hard shell capsules has been developed in the 1980s as an alternative to soft gelatin capsules (McTaggart C. et al, 1984). Liquid filling machinery is modified from two piece hard shell encapsulation machines for solid dosage, such as powder and granules (Walker S E et al, GB1,572,226, 1980). These and all other references set forth herein are incorporated herein by reference in their entirety and for all their teachings and disclosures, regardless of where the references may appear in this application.

Empty hard shell capsules are usually supplied to the filling apparatus operators in a “prelock” condition in which the body part is only partially telescoped into the cap. The liquid filling apparatus opens “prelock” capsule by vacuum force and separate it into body and cap, followed by filling liquid into body cavity with apparatus such as what described in U.S. Pat. No. 4,450,877. When liquid filling is complete, the body is then fully telescoped into cap. The locking grooves on body and cap lock into each other and prevent the separation of the two parts. Liquid filled capsules then are transferred to either a banding machine (such as U.S. Pat. No. 4,584,817, WO 2006/070578), or a microspray fusing machine (such as U.S. Pat. No. 4,724,019) or a ultrasonic welding machine (Lightfoot K. D. 2013), for sealing the overlapping part of cap and body, where any gaps can lead to leaking of liquid.

The two step process of traditional methods of liquid filling hard shell capsules described above gives ample time for releasing pneumatic pressure inside the locked capsules. The pneumatic pressure is produced during closing and locking of the two piece of capsules where liquid filled body acts like a piston and compress the air inside the cap during closing and locking. Only specially designed liquid fill hard capsules (LFHC) with air vents to relieve the pressure are recommended for liquid filling operations (U.S. Pat. No. 8,715,122). Also, the maximum speed of liquid fill using the traditional method is still significantly slower than soft gel capsules technology can achieve (Macci A. et al, 2018) due to the banding, fusing or welding speed limits.

Besides the two-step process, other drawbacks of traditional method for liquid filling hard shell capsules used in the pharmaceutical, vitamins and food industries are also very apparent: 1) there is a very prominent air bubble in each filled capsule that occupy about 30% of usable filling volume of capsule; 2) LFHC capsules required are very expensive; 3) cost is higher in comparison to soft gel technologies for delivery of same dosage due to its complexity and slow speed.

A need exists to streamline and improve the traditional liquid fill process for hard shell capsules and make it one continuous process, therefore, eliminate the need for post-filling banding, fusing or welding. U.S. Pat. No. 4,263,251 disclosed method and apparatus for making one piece hard shell capsules intended for liquid fill that simulated contours of two piece hard shell capsules, but it does not utilize the mass produced two piece hard shell capsules in the market place. JP-S5780318(3) disclosed method of using multiple layer of capsules to seal liquid filled capsules, however, such process will further inflate the costs of traditional liquid filling process. U.S. Pat. No. 4,250,997 revealed methods of sealing the liquid filled capsules with gelling material, such as gelatin but still require banding, therefore, does not streamline the process nor improve its efficiency. U.S. Pat. No. 8,590,278 attempts to use gas pressure differential method to draw in sealing solution for already filled capsules, but that will introduce more variable components into an already complex method and further inflate air bubble size. U.S. Pat. No. 3,159,546, SU1393309 and FR2477014 all revealed method of sealing hard shell capsules, but not for the purpose of liquid fill and did not provide methods of how to fill liquid.

A further need exists to reduce the prominent air bubble size of liquid filled capsules produced by traditional liquid filling processes and apparatus, especially for transparent and translucent capsules. The air bubble in traditionally filled liquid capsules is not only visually unattractive, but also wasting about 30 percent of total filling space. Furthermore, air bubbles contain significant amount of oxygen that could oxidize the very important bio-active ingredients, such as unsaturated fatty acids and antioxidants. Traditional liquid filling method and apparatus only fill liquid into the body cavity and using cap merely as a closure without any fillings for the cap cavity. Upon telescoping the filled body into cap for closing, air between filled liquid to the roof of cap dome is trapped and forms the prominent air bubble in of locked liquid filled capsule. Furthermore, the trapped air in this space also makes the closing and locking of capsule difficult (EP1,213,004A2) and prevents immediate banding, fusing or welding. AU700760B2 attempts using a replacement cap that will take all the air space of a container, however, this patent does not teach how to fill the container or how to seal the container after replacement of the caps. U.S. Pat. No. 4,231,211 teaches filling the air space of already liquid filled capsules with sealants and used a sealant ball for sealing the opening but did not teach the filling of liquid and sealing of the body or cap after liquid filling process.

A further need exists to utilize cheaper mass produced two piece hard shell capsules other than the LFHC capsules for liquid filling in order to be more competitive with soft gel capsules technology.

The present embodiments meet all these needs.

### SUMMARY OF THE INVENTION

Accordingly, the present provides a hard capsule unit for accepting a liquid payload for pharmaceutical or nutraceutical use, comprising: an elongate body portion; a cap portion telescoped onto the body portion and fused therewith to define a fused empty two-piece hard-shell (FETH) capsule unit having a payload cavity; and a fill hole defined on a center of a dome of the cap portion and in communication with the payload cavity.

In some embodiments, the elongate body portion includes a first locking groove defined thereon and the cap portion includes a second locking grove defined thereon that is complementary to the first locking groove, and wherein the first locking groove is mated with the second locking groove.

In another aspect, the present invention provides a method of filling a two-piece telescoping hard capsule comprising a body portion and a cap portion with a liquid, the method comprising the steps of: providing a fill hole on a center of a dome of either the cap portion or the body portion of a hard shell capsule; fusing the cap portion to the body portion to provide a fused empty two-piece hard-shell (FETH) capsule unit; orienting the FETH capsule such that the fill hole is on top; dispensing the liquid into the FETH capsule unit from a nozzle inserted into the fill hole; and sealing the fill hole after the nozzle is removed.

In some embodiments, the step of fusing the cap portion to the body portion to provide a FETH capsule unit comprises applying a fusing solution to a first locking groove of the body portion, telescoping the body portion into the cap portion into a locking position, and quick drying of the fusing solution.

In some embodiments, the step of sealing the fill hole comprises dripping a droplet of a sealing solution on the fill hole followed by quick drying of the one droplet.

In some embodiments, the quick drying is performed by the application of one or more of heat, dried air, infrared radiation, microwave radiation, and ultrasound radiation to the one droplet.

In some embodiments, the sealing solution comprises: at least one solvent selected from one or more of water and lipophobic solvent; at least one film forming agent selected from one or more of gelatin, starch or its derivatives, cellulose or its derivatives, pullulan or its derivatives, PVA, and gums; at least one rheology modifiers selected from one or more of cellulose derivatives, starch or its derivatives, and gums selected from one or more of guar gum, gum arabic, xanthan gum, alginates, carrageenan and gellan gum; an optional wetting agent; plasticizers, coloring agent, release modifying agents, enteric coating material and surfactants as deemed necessary to match the original composition of FETH capsule; and an optional gliding agent.

In some embodiments, the sealing solution composition is adjusted such that: the sealing solution has a viscosity at operating temperature between 500-2500 CP/M⁻¹S⁻¹, and the percentage of water ≤95%; the sealing solution has a contact angle of the one droplet with the FETH capsule surface is in the range of 10°-45°; the sealing solution has a contact angle of the one droplet with the liquid in the FETH capsule is in the range of 140°-180°; and the droplet formed under surface tension has a diameter at its largest point at least 30% larger than a diameter of the filling hole. In some embodiments, the percentage of water ≤80%.

In some embodiments, the coloring agents comprises at least one of azo-, quinophthalone-, triphenylmethane, xanthene- or indigoid dyes, iron oxides or hydroxides, titanium dioxide, natural dyes, and combinations thereof, to be in a range from about 0.001 percent to about 2 percent based upon the weight of the solution.

In some embodiments, the enteric coating agent comprises at least one of HPMC Acetate Succinate, HPMC Phthalate, Cellulose Acetate Phthalate, PVA Phthalate, methacrylates, and combination thereof, to be in the range from about 0.1 percent to about 30 percent based upon the weight of the solution.

In another aspect, the present invention provides a method of producing a hard capsule unit for accepting a liquid payload for pharmaceutical or nutraceutical use, the method comprising: providing a fill hole on a center of a dome of either the cap portion or the body portion of the FETH capsule; obtaining a closed unit of a two-piece telescoping hard capsule comprising a cap portion telescoped onto a body portion; and fusing the cap portion to the body portion to provide a fused empty two-piece hard-shell (FETH) capsule unit.

In some embodiments, the step of providing a fill hole comprises forming the fill hole with a pin bar during an automatic dipping cycle in the manufacture of the cap.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts processing diagrams of top liquid filling method according to one or more embodiments

FIG. 2 depicts process of producing ready-to-use “Fused, Empty, Two-Pieces Hard-Shell” (FETH) capsules with a filling hole on the center of either body or cap dome.

FIG. 3 is a photo of a filling hole on the center of cap dome of a FETH capsule according to one or more embodiments.

FIG. 4 depict designs of a modify dipping pins to make ready-to-use FETH capsules with a filling hole on the center of dome

FIG. 5 depict designs of FETH segments that fit the size and contour of ready-to use FETH capsules.

FIG. 6 depicts Holding Plate design that will lock down the capsules in the immobile position.

FIG. 7 are photos that compares the air bubble of #00 size top liquid filled FETH capsules to air bubble of #00 size liquid filled capsule by traditional method.

The present embodiments are detailed below with reference to the listed figures

### DETAILED DESCRIPTION OF THE EMBODIMENTS

The present embodiments demonstrate a method of filling liquid through filling hole on top of vertical fused capsules and may hereafter referred to as top filling method from time to time.

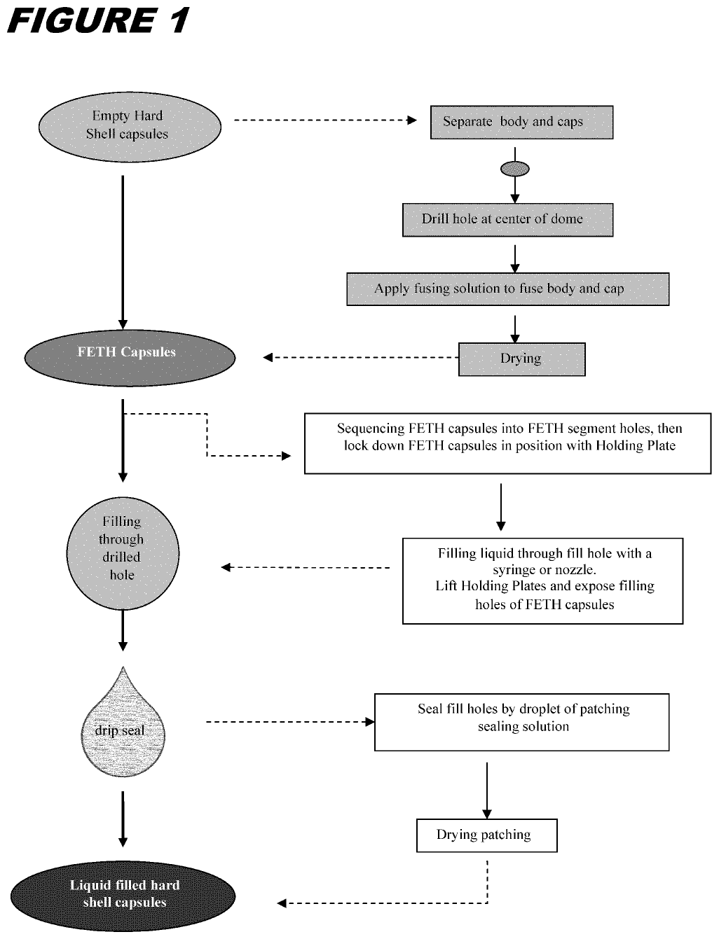

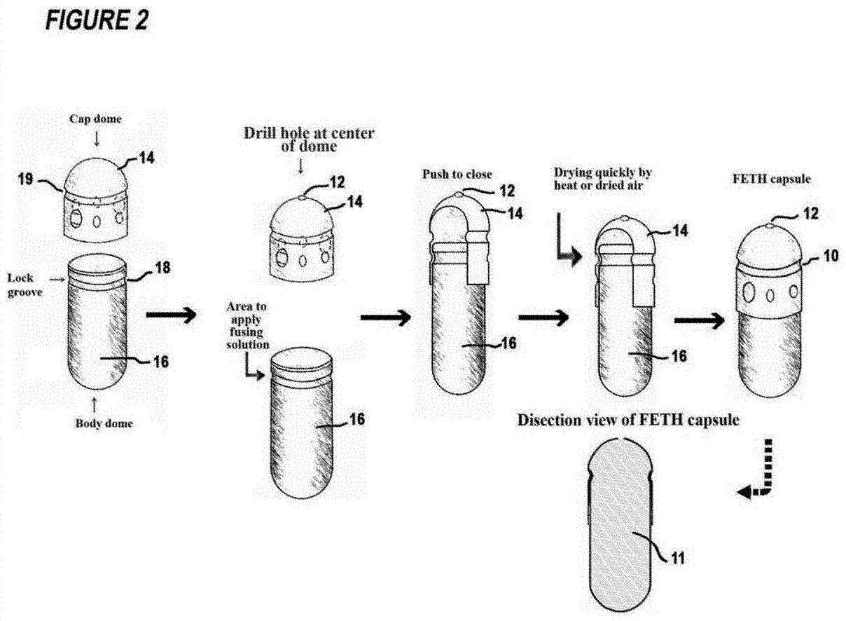

The embodiment of novel top filling method and apparatus perform through following processing steps, as illustrated in FIG. 1:
a) producing ready-to-use “Fused Empty Two-pieces Hard-shell” (FETH) capsule 10, and hereafter referred to as FETH capsule that defines a payload cavity 11 and has a filling hole 12 on the center of a dome, either dome on the cap 14 or dome on the body 16 of capsule, as shown in FIG. 2;
b) liquid fill apparatus operators sequence the FETH capsules into FETH capsules segments 30 that replace traditionally liquid filling machines segments, place Holding Plates 40 on top of FETH segments 30 to hold the FETH capsules 10 tight in a vertically upright and immobilized position;
c) fill liquid into the FETH capsules 10 through the filling hole 12 on the dome using syringe or nozzle, where the filling start on the bottom part of the capsules and gradually moving up to top part of the capsules in order to reduce foaming. Remove Holding Plates 40 to expose drilled holes 12 of FETH capsules 10 after liquid filling;
d) patch the fill hole 12 of FETH capsules 10 by dripping one droplet of patch solution to the center of fill hole 12. Dry the patch sealing solution quickly by heat, dry air, microwave, infrared (IR), ultrasound or combinations thereof.

In embodiments, FETH capsules 10 used in the Top Fill method can be made from any film forming composition comprise of following: 1) solvents such as water or ethanol, 2) film forming agents such as gelatin, glue, starch and its derivatives, cellulose or derivatives, pullulan or derivatives, PVA and polysaccharide gums; 3) rheology modifiers, such as xanthan gum, alginates, carrageenan and gellan gum; 4) choices of plasticizers, pigments, delayed release modifying agents, enteric material and surfactants if necessary.

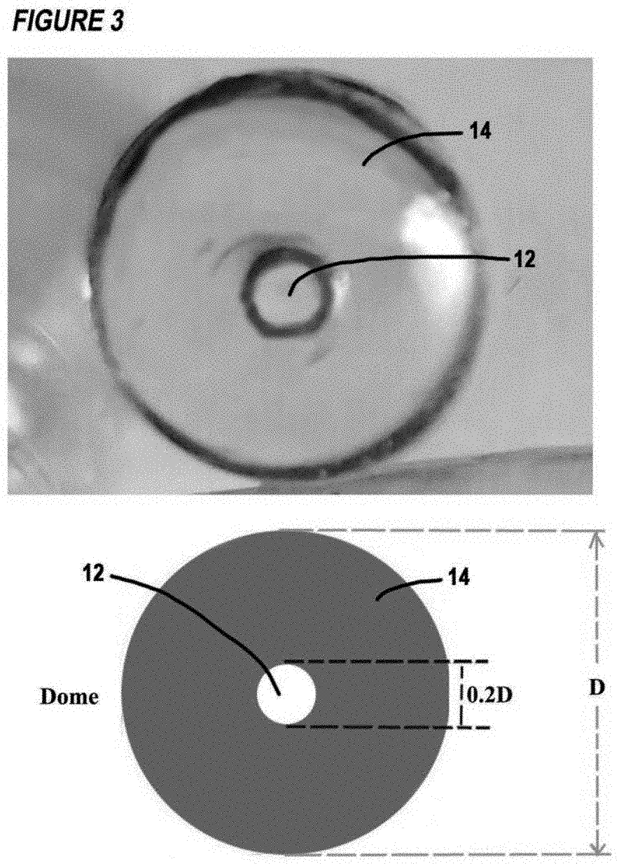

In embodiments, filling hole 12 of FETH capsules 10 can be drilled on the center of the domes of either cap 14 or body 16 of empty hard shell capsules by either mechanical, laser or any other means. FIG. 3 show a drilled fill hole 12 on a clear #00 pullulan based Bright-Poly Organic capsule and the design of the size and position of the filling hole. The round filling hole 12 has diameter about 10-35%, preferably about 20% of the diameter of the capsule body 16 or cap 14. However, the diameter of fill hole 12 can be adjusted to fit various conditions, but it must be about 10-20% larger than the outside diameter the filling syringe or nozzle. The ideal filling holes size will not only render smooth filling, but also utilize the escaping air from the inside of FETH capsules to blow on the filling syringe or nozzle surface and act as a self-cleaning force during filling. The self-cleaning force by escaping air can prevent dripping of liquid from syringe or nozzles on to the surface of capsule domes or the opening holes, therefore eliminate any chances of patch sealing failure. The smaller the gap between syringe or nozzle and the drilled filling hole on FETH capsules, the stronger the force of self-cleaning.

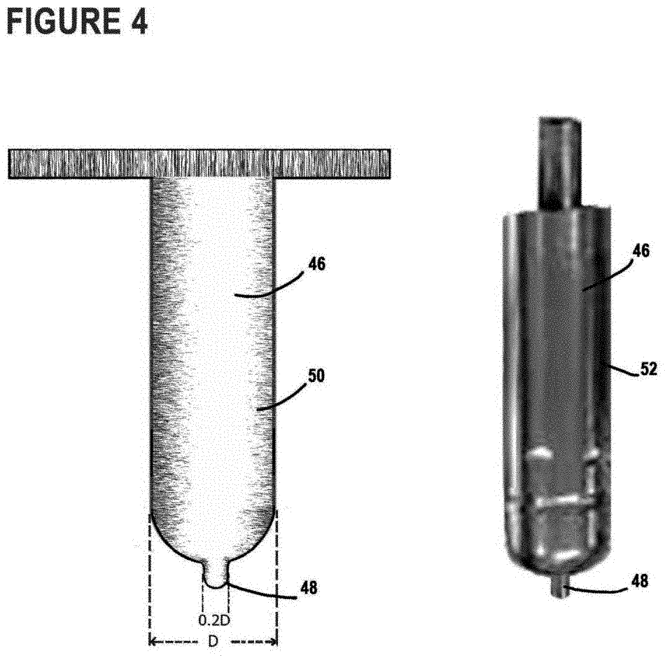

In embodiments, filling hole 12 of FETH capsules 10 can be formed on the center of the dome of the cap 14 or body 16 with a dipping pin bar design such as dipping pin bar 46 during a dipping manufacturing process of the cap 14 or body 16 of the capsule, which is the preferred manufacturing process for hard capsules. A fill hole tip 48 with diameter about 10-35%, preferably about 20%, of diameter of body portion 50 or cap portion 52 of the dipping pin bar 46 is provided on the center of either portion, as illustrated in FIG. 4. After regular dipping process of capsules manufacturing, a fill hole will be formed on center of either cap 14 dome or body 16 dome. After cutting out the excess from surface of the dome, a filling hole on the center of the dome is formed.

In embodiments, FETH capsules 10 with a fill hole 12 are produced by applying thin strip or layer of fusing solution onto the entire locking groove 18 of the body 16 of capsules without leaving any gap. The fusing solution can be applied through various means, for example using a squeeze tip or nozzle while turn the body 360 degree. The thickness of the strip or layer of fusing solutions should be about 5-60 μm (micron), preferably about 20 μm (micron). The filling hole 12 on the center of the dome will release any air pressure when telescoping the body 16 telescope into cap 14 for full closure and locking, therefore, render the method applicable for any capsules, with or without air vents, to make into FETH capsules. After locking of FETH capsules, immediately dry the fusing solution by applying heat or dry air or combination thereof. Other methods of drying also can be employed, such as passing capsules through a microwave oven, infrared (IR) tunnel, drying tunnel, ultrasound chamber or simply natural evaporation.

In embodiments, the FETH capsules can be produced in various optional settings. One preferred setting is at the empty hard shell Capsules manufacturing location, where FETH capsules with a filling hole on cap or body dome can be produced by using FETH capsule pins and adding extensions to traditional automatic capsule dipping machines. The extensions will form filling hole on the dome of cap or body, applying fusing solutions, push capsules into locking position. Immediately dry the fusing solution by one of combination of following: heat, dry air, microwave, infrared (IR), ultrasound or natural evaporation. The ready-to-use FETH capsules made by capsules manufacturer then can be shipped to liquid filling apparatus operators worldwide.

In embodiments, the FETH capsules can be produced in other optional setting, such as at liquid filling apparatus operators' location where empty hard shell capsules are sequenced and opened with encapsulation machines. After separating body and cap, drill a hole on the dome of either cap or body using either mechanical, laser or other drilling methods, apply fusing solutions onto the surface of locking groove. Then close the capsules and push the two piece hard shell capsule into locking position. Immediately dry the fusing solution by one of combination of following: heat, dry air, microwave, infrared (IR), ultrasound or natural evaporation.

In embodiments, fusing solution consists of following ingredients or combination thereof: 1) at least one solvent such as water, organic solvent or combinations; 2) at least one rheology modifier or gelling agent, such as gelatin, starch and its derivative, cellulose and its derivatives, pullulan and its derivatives, PVA, polysaccharide gums or combination thereof; 3) choice of acid resistant enteric material, pigments and surfactants when deemed necessary. The fusing solution to be made with viscosity range between 100-3500 CP/M⁻¹S⁻¹, preferably between 500-1500 CP/M⁻¹S⁻¹ to reduce dripping.

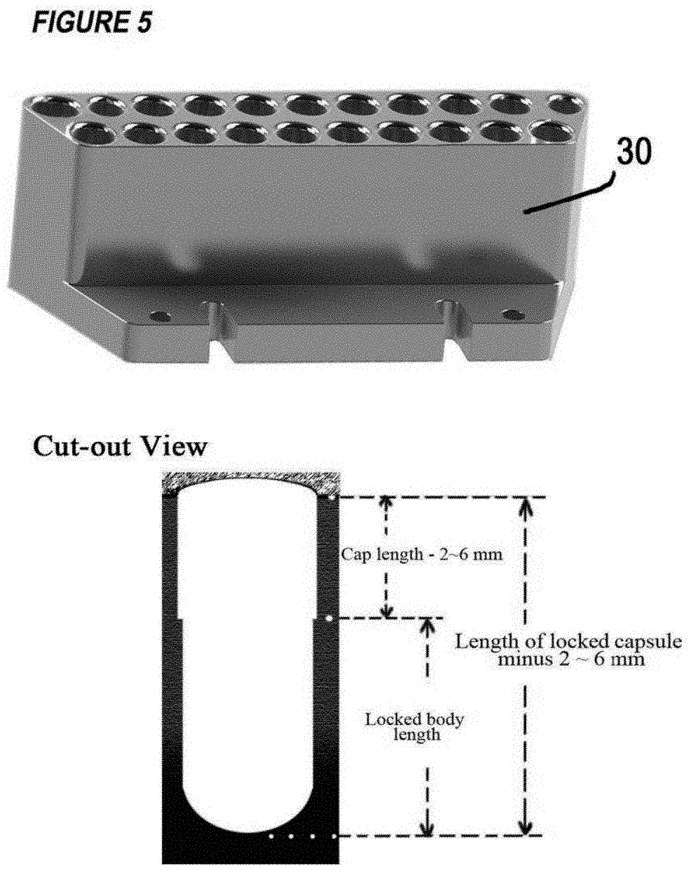

The embodiments relate to top liquid filling method where FETH capsules are sequenced using current encapsulation machines into FETH capsule segments 30 that are modified from current encapsulation machine segments, as illustrated in FIG. 5. The FETH capsule segments 30 are designed to fit the shape and contour of FETH capsules 10. The lower and upper segments of traditional encapsulation machines such as Bosch encapsulator, are shortened and fused into one block to fit the length and contour of FETH capsules. The height reduction is measured to leave 1-7 mm, preferably 2-6 mm of FETH capsules exposed, and rest of the FETH capsules fit into the FETH segments. The exposed part of FETH capsules is designed to be covered by Holding Plates 40 described in next paragraph.

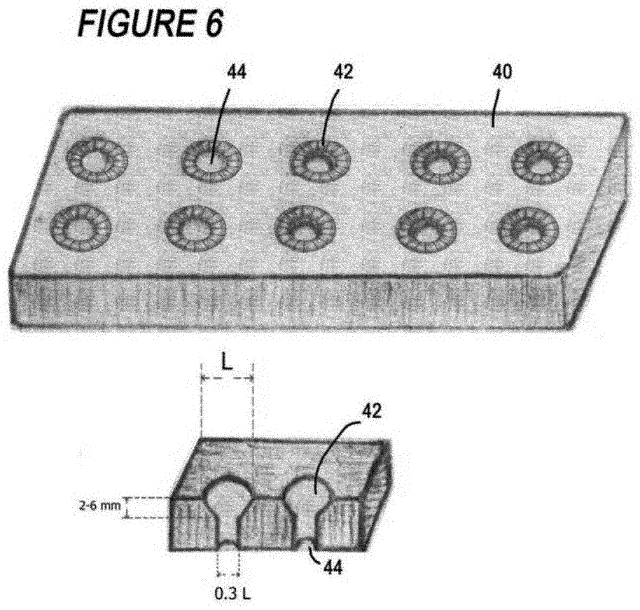

The embodiments relate to top liquid filling method where the Holding Plate 40 design is illustrated by FIG. 6. The Holding Plate 40 are designed with: 1) cylinder cavities 42 that fit the shape, size and contour of either cap end or body end of FETH capsules, depending on which end has filling hole 12, provided on one side with about 1-7 mm, preferably 2-6 mm depth; 2) the number and position of the cylinder cavities shall match exactly on the FETH segments; 3) smaller hole 44 drilled on the center of cylinder cavities 42 through the Holding Plate for entry and withdraw of filling syringe head, the diameter of the smaller hole 44 is about 10-40%, preferably 30% of the diameter of the cylinder cavities 42, to allow entry and exit of syringe filling head, as shown in the section drawing in FIG. 6.

The embodiments relate to top liquid filling method where the combination of Holding Plate 40 on top of FETH capsule segments 30 shall ensure the full enclosure and immobilization of FETH capsules in strict vertical position.

In embodiments related to top liquid filling method where a retractable type feeding syringe or nozzle insert through the small filling hole 44 of both Holding Plate 40 and FETH capsules 10, and fill liquids into the FETH capsules starting on the bottom part of the capsules by extend the filing nozzle or by raising the holding blocks of FETH capsules, and then gradually filling the top part of the FETH capsules in order to reduce foaming. The retractable syringe or nozzle can be designed to have two hollow channels, one channel for delivery of liquid into the FETH capsules and another channel for sucking away any excessive liquid.

In embodiments related to top liquid filling method where construction material for retractable filling syringe or nozzle should be lipophobic. During liquid filling process, the escaping air through drilled hole of FETH capsules will blow onto the feeding nozzle, effectively acting as self-cleaning air stream. Lipophobic material construction of syringe type feeding nozzle or tip can enhance the effectiveness of self-cleaning process.

In embodiments related to top liquid filling method where the outer diameter size of syringe type feeding nozzle should be chosen to take up about 60-90% of the area of the drilled hole on FETH capsules. The choice of the syringe size depends on following factors: 1) viscosity of the filling liquid; 2) FETH drilled hole size; 3) force of self-cleaning air needed during operation.

In embodiments related to top liquid filling method where multiple filling syringe or nozzles can be used at same time to fill FETH capsules inside the FETH segments and holding plates. The immobilized FETH capsules adopt fixed upright position enable interlocked mechanical mechanism for multiple filling; therefore, multiply the speed of liquid filling process.

The embodiments relate to top liquid filling method, Holding Plate is be moved away to expose filling hole of FETH capsule for drip patch sealing. Droplet of patch sealing solution is dripped on to the center of filling hole of FETH capsules. Force of surface tension between patch sealing solution droplets and FETH capsule surface, and contour of the FETH capsules dome will force the patch sealing solution spread evenly and achieve a perfect patch seal after drying by heat, dry air, IR, microwave, ultrasound or combination thereof.

In embodiments related to top liquid filling method where patch sealing solution must possess film forming ability and should match as closely as possible of the filming forming composition of FETH capsule used. The film forming patch solution consists of: 1) at least one solvent such as water, lipophobic solvent; 2) at least one film forming agent, such as gelatin, starch and its derivative, cellulose and its derivatives, pullulan and its derivatives, PVA, gums or combination thereof; 3) at least one rheology modifiers such as cellulose derivatives, starch or derivatives, guar gum, gum Arabic, xanthan gum, alginates, carrageenan and gellan gum; 4) a wetting agent if needed; 5) choice of plasticizers, coloring agent, release modifying agents, enteric coating material and surfactants that are deemed necessary to match the original composition of FETH capsule; 6) a gliding agents if needed.

In embodiments related to top liquid filling method where the patch sealing solution are adjusted by varying its ingredients proportion to meet following requirements
(a) Viscosity at operating temperature between 500-2500 CP/M⁻¹S⁻¹;
(b) Contact Angle with FETH capsule surface: 10≤θ≤45°
(c) Contact Angle with filling material: 140≤θ≤180°
(d) Percentage of water ≤90%, preferably ≤80%;
(e) Droplet formed from sealing solution with diameter at its largest point is about 30% larger than the diameters of drilled holes.

In embodiments related to top liquid filling method where the bubble size reduction of present embodiment is more than 90% in comparison to air bubble size of traditional method. Reduction of the air bubble to negligible or invisible size also can be achieved by adjusting the proportion of patching solution ingredients to meet following requirements:
(a) Viscosity at operating temperature between 900-1500 CP/M⁻¹S⁻¹;
(b) Contact Angle with FETH capsule surface: 10≤θ≤25°
(c) Contact Angle with filling material: 160≤θ≤180°
(d) Percentage of water about 70%;
(e) Droplet formed from sealing solution with diameter at its largest point is about 25% larger than the diameters of drilled holes.

The patch sealing solution will drip into the filling hole of FETH capsules and sit on top of the oil or hydrophobic filling liquid due to the surface tension until dried by heat, dry air, IR, microwave, ultrasound or combination thereof.

In embodiments related to top liquid filling method where the patch sealing solution includes a coloring agent in a range from about 0.001 percent to about 5 percent based upon the weight of the solution to match the original coloring components of the sealed empty hard capsules. The coloring agent can be at least one of azo-, quinophthalone-, triphenylmethane, xanthene- or indigoid dyes, iron oxides or hydroxides, titanium dioxide, natural dyes, and combinations thereof.

In embodiments related to top liquid filling method where the patch sealing solution, the present embodiments of top liquid filling method eliminates post filling banding, fusing or welding required by traditional liquid filled method, therefore simplifying the liquid fill process and make liquid filled hard shell capsules more efficient and economical to compete with liquid filled soft gel capsules.

The present embodiments of top liquid filling method eliminated the need for specifically designed liquid fill hard shell capsules (LFHC) by utilize any mass produced two piece hard shell capsules, therefore, further reduces the costs.

In embodiments, the following words, phrases, and symbols are generally intended to have the meanings as set forth below, except to the extent that the context in which they are used indicates otherwise.

The term “about” as used herein is intended to mean approximately, in the region of, roughly, or around. When the term “about” is used in conjunction with a numerical range, it modifies that range by extending the boundaries above and below the numerical values set forth. Unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

The term “capsule” as used herein can refer to either empty or filled capsule shells whereas “shell” specifically refers to an empty capsule. Since the hard capsule shells described herein can be filled with substances in liquid form, the hard capsules may be sealed or banded according to conventional techniques. Alternatively, the hard capsule shells can be manufactured to have a specific capsule shell design that provides certain advantages over conventional techniques, e.g., the ability to pre-lock empty caps and bodies, or completing the filling steps in a different location, or at a specific time.

The term “coloring agent” as used herein can refer to one or more pharmaceutically acceptable agents, food acceptable coloring agents, or mixtures thereof. The coloring agents may be selected from azo-, quinophthalone-, triphenylmethane-, xanthene- or indigoid dyes, iron oxides or hydroxides, titanium dioxide, or natural dyes and mixtures thereof. Further examples are patent blue V, acid brilliant green BS, red 2G, azorubine, ponceau 4R, amaranth, D+C red 33, D+C red 22, D+C red 26, D+C red 28, D+C yellow 10, yellow 2 G, FD+C yellow 5, FD+C yellow 6, FD+C red 3, FD+C red 40, FD+C blue 1, FD+C blue 2, FD+C green 3, brilliant black BN, carbon black, iron oxide black, iron oxide red, iron oxide yellow, titanium dioxide, riboflavin, carotenes, anthocyanines, turmeric, cochineal extract, chlorophyllin, canthaxanthin, caramel, betanin and Candurin® pearlescent pigments. Candurin® is manufactured and marketed by Merck KGaA®, Darmstadt, Germany and consist of titanium dioxide and/or iron oxide—approved food and pharmaceutical colorants in many countries—and potassium aluminum silicate as color carrier.

In embodiments, the pharmaceutically acceptable coloring agents, food acceptable coloring agents, or mixtures thereof are present in an amount ranging from about 0 to about 5 percent by weight, e.g., from about 0 to about 2.5 percent by weight, and from about 0 to about 1.5 percent by weight over the total weight of the aqueous composition.

The term “filling liquid” as used herein is intended to mean any hydrophobic, oil or solvent based liquid, semi-liquid or paste to be encapsulated into the two piece hard shell capsules used in pharmaceutical, food and vitamin industry.

The term “film forming solution” as used herein can refer to material used as base for hard capsule shells. Examples include HPMC (e.g. HPMC types 2910, 2906 and/or 2208 as defined in USP30-NF25), gelatin, pullulan, PVA and non-enteric starch derivatives, such as hydroxypropyl starch or combination thereof.

The term “hard capsules” as used herein can refer to capsules intended for oral administration to human or animal subjects. The hard capsules described herein can be manufactured using different processes, such as the dip molding processes as well as the use of conventional equipment, pin molds can be dipped into an aqueous-based film forming solution and subsequently withdrawn. The film formed on the molding pins surface can then be dried, stripped off the pins and cut to a desired length, thereby obtaining the capsules caps and bodies. Normally, caps and bodies have a side wall, an open end and a closed end. The length of the side wall of each of said parts is generally greater than the capsule diameter. The capsule caps and bodies can be telescopically joined together so as to make their side walls partially overlap and obtain a hard capsule shell.

The term “FETH capsules” as used herein refer to empty hard shell capsules with an filling opening (filling hole) on the center of cap or body dome, intended for oral administration to human or animal subjects. The hard capsules described herein can be manufactured using different processes, such as the dip molding processes as well as the use of conventional equipment, pin molds can be dipped into an aqueous-based film forming solution and subsequently withdrawn. The film formed on the molding pins surface can then be dried, stripped off the pins and cut to a desired length, thereby obtaining the capsules caps and bodies, followed by fusion of body and cap.

The term “optional” or “optionally” as used herein can mean that the subsequently described event or circumstance may or may not occur, and that the description includes instances where the event or circumstance occurs and instances in which it does not.

The term “rheology modifier” as used herein can refer alginates, agar gum, guar gum, locust bean gum, carrageenan, tara gum, gum arabic, ghatti gum, Khaya grandifolia gum, tragacanth gum, karaya gum, pectin, arabian (araban), xanthan, gellen, starch, Konjac mannan, galactomannan, funoran, and other exocellular polysaccharides. The amount of rheology modifier can preferably be in the range of 0.1 to 1.5 percent by weight.

The term “processing steps” herein is intended to mean one logical instance of production orders. When the term “processing steps” is used it includes other modifications of re-arrangement of the manufacturing orders of the process. Unless otherwise indicated, it should be understood that processing steps set forth in embodiments and attached claims are only one variant of the logical arrangements.

Now turning to the Figures. FIG. 1 depicts one of ideal streams of processing flow chart of present invention. Other optional configuration of the processing steps can achieve the same goal.

FIG. 2 illustrates process steps of producing FETH capsules from any two piece hard shell capsules, made of any material. The present invention utilize any types of two piece hard shell capsules consist of two spherical parts of body 16 and caps 14 for pharmaceutical, food and vitamin for producing FETH capsules by applying a strip of fusing liquid into the locking groove regions 18 and 19 of the body and cap, at same time drill a hole 12 on the dome of cap 14 or body 16 by laser, mechanical drill or other form of forces. Push to close and lock the capsules and dry the fusing solution using heat, dry air, IR, microwave, ultrasound or combination thereof. The goal is to produce fused capsules 10 that its body and cap can not move position without destroy it.

FIG. 3 depicts a drilled hole 12 on cap 14 dome of FETH capsule.

FIG. 4 depicts a design of modified dipping pin 46 for making FETH capsules. The modification on dipping pins used by conventional hard shell capsules manufacturing will simplify the FETH capsule manufacturing process by eliminate the need for drilling a filling hole on center of dome, thus enable making ready-to-use FETH capsules in one single dipping process.

FIG. 5 depicts design of FETH segments that will fit the size and contour of FETH capsules. The upper and lower segments of current encapsulation machines, such as Bosch encapsulator will be shortened and fused. The height of the FETH segment capsule hole cavity for holding FETH capsules will be shorter than FETH capsules by 1-7 mm, preferably by 2-6 mm, so a Holding Plates with hole depth of 1-7 mm, preferably by 2-6 mm, can be mounted on top of the FETH segments and fully enclose and immovable the FETH capsules will for liquid filling.

FIG. 6 depicts designs of a Holding Plates used to lock down the position of FETH capsules into the FETH capsule segments. Capsule holding cavities fitting the size and contour of FETH capsule with depth of 1-7 mm, preferably 2-6 mm are bore on side of Holding Plates. Smaller round hole for are bore on the other side of the Holding Places for entry and exit of filling syringe. Holding Plates are to be mounted on top of the FETH capsule segments. Combined Holding Plate and FETH segment enclose and secure the FETH capsules immobile.

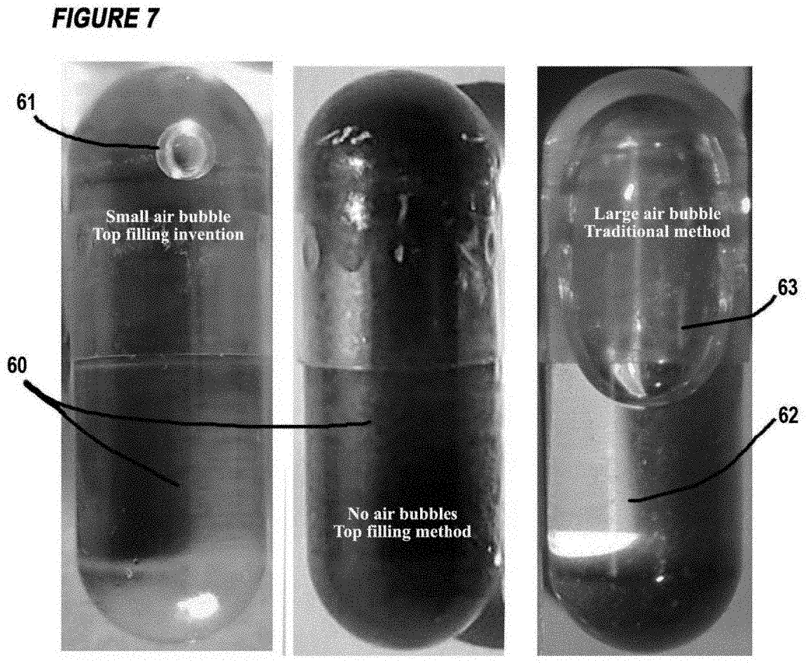

FIG. 7 are picture comparison of air bubble size 61 in a liquid filled FETH capsules 60 using present embodiment to air bubble size 63 in conventional liquid filled capsule 62. The air bubble size of present invention can be even reduced further to negligible level by adjusting the composition of drop sealing liquid.

### EXAMPLES

The following includes but is not limited to examples of manufacturing liquid filled hard shell capsules with present embodiment.

Method of measuring air bubble size. There is no official method for this purpose in pharmacopeias. The size of air bubble can change shape and appearance depends on its position and pressure inside the capsule. Therefore, a scientifically repeatable method is improvised to evaluate the amount of air inside the capsules. In order to balance the air pressure of the liquid filled capsules with outside atmosphere, measurement of air bubble size to be carried out at least 24 hours after the liquid filling operation. Following is the description of method we used for measuring air volume for indication of bubble size:

Set liquid filled capsules upright, insert a transparent syringe needle into the center of the capsules where the air bubble is located to act as a vent; Use a volumetric syringe with a small gauge needle, such as gauge 33 needle to inject the same filling liquid into the filled capsules until the air bubble disappear completely from the capsule. Use slight inject and suck function to monitor the exact fill line by watching the appearance of liquid in the transparent needle. The volume of injected liquid when air bubble disappears is the measurement of air volume of the bubble.

A NJP-3000 encapsulation machine that is capable of running at 180,000 capsules per hour is modified to fit FETH segments and holding plates. Multiple piston pumps are installed to supply multiple filling nozzles. A conveyer carrying FETH segments are build to transport filled and patch sealed FETH capsules to a heating tunnel by blowing 32 degree Celsius and 10% relative humidity air from top. This machine is used to test the maximum speed of the current embodiments.

### Example 1

Manufacturing Organic FETH capsules: A filling hole of 2.2 mm is drilled with mechanical drill on the center of cap of NOP Certified Bright-Poly organic capsules size #00, then apply fusing solution comprise of 99.5% water and 0.5% xanthan gum on the groove of body of the capsule. Telescopically push and close the capsules to its locking position and apply dried air for 3 minutes.

NJP-3000 encapsulation machine is running at one third of its maximum speed, at 60,000 capsules per hour. A 17 gauge syringe filling head with 1.07 mm of inner diameters is used to fill the FETH capsules. Certified organic flax seed oil was purchased commercially to fill the FETH capsules. After filling, droplet of patch sealing dripped on the filling hole of FETH capsules and dried by blowing dry air at 28 degree Celsius and humidity of 11%. Drip patch sealing solution consists of 26% organic pullulan powder, 1% of xanthan gum powder, 1% gellan gum powder and 72% of water.

A parallel comparison filling using traditional filling method also performed as reference. 24 hours after filling complete, measure the air bubble size, perform leaking capsules check and measuring disintegration time using USP Method <701>.

Results are shown below.

| Method | Top Filled FETH capsules | | Traditional Liquid Fill | |
|---|---|---|---|---|
| Running Speed | 60,000 per hour | | 18,000 per hour | |
| Fill volume | 0.90 | ml | 0.71 | ml |
| Air bubble size | 0.01 | ml | 0.20 | ml |
| Leaker check | <20/10,000 | | <20/10,000 | |
| Disintegration time | 9 | minutes | 9 | minutes |

When the NJP-3000 encapsulation machine is running at one third of its maximum speed, at 60,000 capsules per hour, it is already exceeding the speed of most traditional liquid filling method for hard shell capsules. The test results also indicated clearly other advantages of top filling FETH capsules over traditional filling method: 1) significantly reduced air bubble size and improves its appearance; 2) significantly increased dosage delivery for the same capsule by 28%.

Furthermore, the advantages of present embodiment are not only confined to physical form changes, the present embodiment provides an avenue for producing 100% certified organic liquid capsules that are not available thus far in the market place although it is highly demanded by vitamin and food industry.

### Example 2

Manufacturing Organic FETH capsules: A filling hole of 2.2 mm is drilled with mechanical drill on the center of cap of NOP Certified Bright-Poly organic capsules size #00, then apply fusing solution comprise of 99.5% water and 0.5% xanthan gum is on the groove of body of the capsule. Telescopically push and close the capsules to its locking position and apply dried air for 3 minutes.

NJP-3000 encapsulation machine is running at two third of its maximum speed, at 120,000 capsules per hour. A 17 gauge syringe filling head with 1.07 mm of inner diameters is used to fill the FETH capsules. Certified organic flax seed oil was purchased commercially to fill the FETH capsules. After filling, droplet of patch sealing dripped on the filling hole of FETH capsules and dried by blowing dry air at 28 degree Celsius and humidity of 11%. Drip patch sealing solution consists of 26% organic pullulan powder, 1% of xanthan gum powder, 1% gellan gum powder and 72% of water.

A parallel comparison filling using traditional filling method also performed as reference. 24 hours after filling complete, measure the air bubble size, perform leaking capsules check and measuring disintegration time using USP Method <701>.

Results are shown below.

| Method | Top Filled FETH capsules | | Traditional Liquid Fill | |
|---|---|---|---|---|
| Running Speed | 120,000 per hour | | 18,000 per hour | |
| Fill volume | 0.89 | ml | 0.71 | ml |
| Air bubble size | 0.02 | ml | 0.20 | ml |
| Leaker check | <20/10,000 | | <20/10,000 | |
| Disintegration time | 8 | minutes | 8 | minutes |

When the NJP-3000 encapsulation machine is running at two third of its maximum speed, at 120,000 capsules per hour, it is exceeding the speed any known traditional liquid filling method for hard shell capsules. The test results indicate the filling volume, leakers in the following lot inspection and disintegration time all pass tests.

### Example 3

Manufacturing Organic FETH capsules: A filling hole of 2.2 mm is drilled with mechanical drill on the center of cap of NOP Certified Bright-Poly organic capsules size #00, then apply fusing solution comprise of 99.5% water and 0.5% xanthan gum is on the groove of body of the capsule. Telescopically push and close the capsules to its locking position, and apply dried air for 3 minutes.

NJP-3000 encapsulation machine is running at recommended high speed, at 160,000 capsules per hour. A 17 gauge syringe filling head with 1.07 mm of inner diameters is used to fill the FETH capsules. Certified organic flax seed oil was purchased commercially to fill the FETH capsules. After filling, droplet of patch sealing dripped on the filling hole of FETH capsules and dried by blowing dry air at 28 degree Celsius and humidity of 11%. Drip patch sealing solution consists of 26% organic pullulan powder, 1% of xanthan gum powder, 1% gellan gum powder and 72% of water.

A parallel comparison filling using traditional filling method also performed as reference. 24 hours after filling complete, measure the air bubble size, perform leaking capsules check and measuring disintegration time using USP Method <701>.

Results are shown below.

| Method | Top Filled FETH capsules | | Traditional Liquid Fill | |
|---|---|---|---|---|
| Running Speed | 160,000 per hour | | 18,000 per hour | |
| Fill volume | 0.86 | ml | 0.71 | ml |
| Air bubble size | 0.05 | ml | 0.20 | ml |
| Leaker check | <20/10,000 | | <20/10,000 | |
| Disintegration time | 8 | minutes | 9 | minutes |

When the NJP-3000 encapsulation machine is running at recommended high speed, at 160,000 capsules per hour, it is almost the same speed of most of the soft gelatin capsules machine at present time. The test results indicate the filling volume, leakers in the following lot inspection and disintegration time all pass tests.

### Example 4

Manufacturing Organic FETH capsules: A filling hole of 2.2 mm is drilled with mechanical drill on the center of cap of NOP Certified Bright-Poly organic capsules size #00, then apply fusing solution comprise of 99.8% water and 0.2% xanthan gum is on the groove of body of the capsule. Telescopically push and close the capsules to its locking position and apply dried air for 3 minutes.

A 17 gauge syringe filling head with 1.07 mm of inner diameters is used to fill the FETH capsules. Certified organic flax seed oil was purchased commercially to fill the FETH capsules. After filling, droplet of patch sealing dripped on the filling hole of FETH capsules and dried by blowing dry air at 28 degree Celsius and humidity of 11%. Drip patch sealing solution consists of 29% organic pullulan powder, 0.6% of xanthan gum powder, 0.41% gellan gum powder and 70% of water.

A parallel comparison filling using traditional filling method also performed as reference. 24 hours after filling complete, measure the air bubble size, perform leaking capsules check and measuring disintegration time using USP Method <701>.

Results are shown below

| Method | Top Filled FETH capsules | | Traditional Liquid Fill | |
|---|---|---|---|---|
| Running Speed | 30,000 per hour | | 18,000 per hour | |
| Fill volume | 0.91 | ml | 0.70 | ml |
| Air bubble size | 0.00 | ml | 0.21 | ml |
| Leaker check | <20/10,000 | | <20/10,000 | |
| Disintegration time | 8 | minutes | 9 | minutes |

From results above, the top filling method of present embodiment eliminated the air bubble completely in liquid filled hard shell capsules when slow down the filling speed to allow fine tune of the filling and patching operations.

### Example 5

Manufacturing of Organic FETH capsules: A filling hole of 2.2 mm is drilled with mechanical drill on the center of cap of NOP Certified Bright-Poly capsules size #00, then fusing solution comprise of 95% water and 5% organic pullulan is applied on the groove of body of the capsule. Telescopically push and close the capsules to its locking position and apply dried air for 5 minutes.

A 17 gage feeding syringe with 1.07 mm of inner diameters is used to fill the FETH capsules for triglycerides form of Fish oil with 30% total omega 3. After liquid filling, drip patch sealing droplet applied on the drilled hole and dried by blowing dried air with temperature of 35 degree Celsius and humidity of 5%. Drip patch sealing solution consists of 16% organic pullulan powder, 5% organic starch, 3% of xanthan gum powder, 1% sodium alginates and 75% of water.

A parallel comparison filling using traditional filling method also performed as reference. 24 hours after filling complete, measure the air bubble size, perform leaking capsules check and measuring disintegration time using USP Method <701>.

Results are shown below

| Method | Top Filled FETH capsules | | Traditional Liquid Fill | |
|---|---|---|---|---|
| Running Speed | 120,000 per hour | | 18,000 per hour | |
| Fill volume | 0.89 | ml | 0.71 | ml |
| Air bubble size | 0.02 | ml | 0.20 | ml |
| Leaker check | <20/10,000 | | <20/10,000 | |
| Disintegration time | 9 | minutes | 9 | minutes |

### Example 6

The cellulosed based capsules are becoming a very popular for pharmaceutical and vitamins. Follow example used cellulose derivative based capsules in the present embodiment of top filling FETH capsules.

Manufacturing of Hydroxypropyl Methylcellulose (HPMC) FETH capsules: A filling hole of 2.2 mm is drilled with mechanical drill on the center of cap of JC-Caps Goh-Veg HPMC capsules size #00, then fusing solution comprise of 99.5% water and 0.5% xanthan gum is applied on the groove of body of the capsule. Telescopically push and close the capsules to its locking position and apply dried air for 5 minutes.

A 17 gage feeding syringe with 1.07 mm of inner diameters is used to fill the FETH capsules for triglycerides form omega 3 fish oil. After filling, droplet of patch sealing dripped on the filling hole of FETH capsules and dried by blowing dry air at 28 degree Celsius and humidity of 11%. Drip patch sealing solution consists of 23% HPMC USP powder, 3% of xanthan gum powder and 1% gellen gum powder and 73% of water.

A parallel comparison filling using traditional filling method also performed as reference. 24 hours after filling complete, measure the air bubble size, perform leaking capsules check and measuring disintegration time using USP Method <701>.

Results are shown below

| Method | Top Filled FETH capsules | | Traditional Liquid Fill | |
|---|---|---|---|---|
| Running Speed | 120,000 per hour | | 18,000 per hour | |
| Fill volume | 0.89 | ml | 0.71 | ml |
| Air bubble size | 0.02 | ml | 0.20 | ml |
| Leaker check | <20/10,000 | | <20/10,000 | |
| Disintegration time | 8 | minutes | 9 | minutes |

### Example 7

Different size cellulosed based capsules are used in the present embodiment of top filling FETH capsules to examine the fill volume and air bubble size.

Manufacturing of HPMC FETH capsules: A filling hole of 1.95 mm is drilled with mechanical drill on the center of cap of JC-Caps Goh-Veg HPMC capsules size #0, then fusing solution comprise of 70% water, 29.7% ethanol food grade and 0.3% HPMC is applied on the groove of body of the capsule. Telescopically push and close the capsules to its locking position and apply dried air for 3 minutes.

An 18 gage feeding syringe with 0.84 mm of inner diameters is used to fill the FETH capsules for fish oil with 300 mg of triglycerides form omega 3. After liquid filling, drip patch sealing droplet applied on the drilled hole and dried by blowing dried air with temperature of 28 degree Celsius and humidity of 10%. Drip patch sealing solution consist of 24% HPMC USP powder, 3% of xanthan gum powder and 1% carrageenan powder and 72% of water.

A parallel comparison filling using traditional filling method also performed as reference. 24 hours after filling complete, measure the air bubble size, perform leaking capsules check and measuring disintegration time using USP Method <701>.

Results are shown below

| Method | Top Filled FETH capsules | | Traditional Liquid Fill | |
|---|---|---|---|---|
| Running Speed | 120,000 per hour | | 18,000 per hour | |
| Fill volume | 0.68 | ml | 0.53 | ml |
| Air bubble size | 0.01 | ml | 0.16 | ml |
| Leaker check | <20/10,000 | | <20/10,000 | |
| Disintegration time | 6 | minutes | 7 | minutes |

Results indicate that the fill volume increased by about 30%.

### Example 8

The gelatin based capsules is the main staple capsules for pharmaceutical industry.

Follow example used bovine gelatin capsules in the present embodiment of top filling FETH capsules.

Manufacturing of gelatin FETH capsules: A filling hole of 2.2 mm is drilled with mechanical drill on the center of cap of JC-Caps gelatin capsules size #00 natural color, then fusing solution comprise of 99.5% water and 0.5% xanthan gum is applied on the groove of body of the capsule. Telescopically push and close the capsules to its locking position and apply dry air at 32 degree Celsius for 5 minutes.

A 17 gage feeding syringe with 1.07 mm of inner diameters is used to fill the FETH capsules for triglycerides form omega 3 fish oil. After filling, droplet of patch sealing dripped on the filling hole of FETH capsules and dried by blowing dry air at 32 degree Celsius and humidity of 10%. Drip patch sealing solution consists of 27% gelatin USP powder, 2% of xanthan gum powder and 1% sodium alginate powder and 70% of water.

A parallel comparison filling using traditional filling method also performed as reference. 24 hours after filling complete, measure the air bubble size, perform leaking capsules check and measuring disintegration time using USP Method <701>.

Results are shown below

| Method | Top Filled FETH capsules | | Traditional Liquid Fill | |
|---|---|---|---|---|
| Running Speed | 120,000 per hour | | 18,000 per hour | |
| Fill volume | 0.88 | ml | 0.70 | ml |
| Air bubble size | 0.03 | ml | 0.21 | ml |
| Leaker check | <20/10,000 | | <20/10,000 | |
| Disintegration time | 10 | minutes | 9 | minutes |

Results indicate gelatin capsules also can be top filled using present embodiment.

### Example 9

Opaque, colored and printed gelatin capsules are essential for differentiation in pharmaceutical industry. Follow example used opaque and colored bovine gelatin capsules in the present embodiment of top filling FETH capsules.

Manufacturing of gelatin FETH capsules: A filling hole of 2.2 mm is drilled with mechanical drill on the center of cap of commercially purchased gelatin capsules size #00 yellow color with composition state of 0.7% titanium dioxide, 0.1% D & C Yellow 10, 0.02% FD & C Red 40 as pigments. The fusing solution comprises of 60% water, 36% ethanol and 4% gelatin is applied on the groove of body of the capsule. Telescopically push and close the capsules to its locking position and apply dry air at 32 degree Celsius for 4 minutes.

A 17 gage feeding syringe with 1.07 mm of inner diameters is used to fill the FETH capsules for triglycerides form omega 3 fish oil. After filling, droplet of patch sealing dripped on the filling hole of FETH capsules and dried by blowing dry air at 32 degree Celsius and humidity of 10%. Drip patch sealing solution consists of 27% gelatin USP powder, 2% of xanthan gum powder, 0.7% titanium dioxide, 0.1% D & C Yellow 10, 0.02% FD & C Red 40 and 50.18% of water and 20% food grade ethanol.

A parallel comparison filling using traditional filling method also performed as reference. 24 hours after filling complete, measure the air bubble size, perform leaking capsules check and measuring disintegration time using USP Method <701>.

Results are shown below

| Method | Top Filled FETH capsules | | Traditional Liquid Fill | |
|---|---|---|---|---|
| Running Speed | 120,000 per hour | | 18,000 per hour | |
| Fill volume | 0.89 | ml | 0.70 | ml |
| Air bubble size | 0.02 | ml | 0.21 | ml |
| Leaker check | <20/10,000 | | <20/10,000 | |
| Disintegration time | 9 | minutes | 9 | minutes |

The patch color basically matched the rest of the colored capsules, only slightly more yellowish upon close inspection on the filling hole due to it is slightly thickness than the rest of the capsule wall.

### Example 10

The ready-to-use, snap close type acid resistant cellulosed based capsules are made available in recent years for delivery of live microbes to by-pass the gastric acid. The acid resistant capsules are used in the present embodiment of top filling FETH capsules to examine the effectiveness.

Manufacturing of HPMC FETH acid resistant capsules: A filling hole of 1.95 mm is drilled with mechanical drill on the center of cap of Bright-GAR gastric acid resistant capsules that are coated with HPMC acetate succinate. The size #0 Bright-GAR capsule is used. The fusing solution comprise of 80% ethanol, 15% water food grade and 5% HPMC acetate succinate is applied on the groove of body of the capsule. Telescopically push and close the capsules to its locking position and apply dried air for 3 minutes.

An 18 gage feeding syringe with 0.84 mm of inner diameters is used to fill the FETH capsules for fish oil with 300 mg of triglycerides form omega 3. After liquid filling, drip patch sealing droplet applied on the drilled hole and dried by blowing dried air with temperature of 28 degree Celsius and humidity of 10%. Drip patch sealing solution consist of 65% ethanol food grade, 10% water, 20% HPMC acetate succinate and 5% CMC sodium.

A parallel comparison filling using traditional filling method also performed on a Bright-GAR acid resistant capsule as reference. 24 hours after filling complete, measure the air bubble size, perform leaking capsules check and measuring intact time in USP simulated gastric acid (SGF) and disintegration time in USP simulated intestine fluid (SIF) using USP <701> method.

Results are shown below

| Method | Top Filled FETH capsules | | Traditional Liquid Fill | |
|---|---|---|---|---|
| Running Speed | 60,000 per hour | | 18,000 per hour | |
| Fill volume | 0.67 | ml | 0.52 | ml |
| Air bubble size | 0.02 | ml | 0.17 | ml |
| Leaker check | <20/10,000 | | <20/10,000 | |
| Intact in USP SGL, | >120 | minutes | >120 | minutes |
| pH 1.0 | | | | |
| Disintegration in | 9 | minutes | 9 | minutes |
| SIF, pH 6.8 | | | | |

Results indicate that the patch sealing works well and did not break the integrity of Bright-GAR gastric resistant capsules in USP simulated gastric acid.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

### LITERATURE CITED

1: McTaggart C. et al., “The evaluation of an automatic system for filling liquids into hard gelatin capsules.” J. Pharm. Pharmacol. 36: 119-121 (1984).
2: Lightfoot K. D. “Capsule Sealing—An overview of capsules sealing equipment” <Tablets & Capsules> January Issue, 2013, CSC Publishing Inc.
3: Macci A. et al “Advances in manufacturing liquid-filled hard and soft capsules for delivery of difficult APIs”<Tablets & Capsules > November Issue, 2018, CSC Publishing Inc.
4: Patents
GB1,572,226
U.S. Pat. No. 4,450,877
U.S. Pat. No. 8,590,278
U.S. Pat. No. 4,584,817
WO 2006/070578
U.S. Pat. No. 4,724,019
U.S. Pat. No. 8,715,122
U.S. Pat. No. 4,263,251
JP-55780318(3)
U.S. Pat. No. 3,159,546
SU1393309
FR2477014
EP1,213,004A2
AU700760B2
U.S. Pat. No. 4,231,211

1. A hard capsule unit for accepting a liquid payload for pharmaceutical or nutraceutical use, comprising:
a. an elongate body portion;
b. a cap portion telescoped onto the body portion and fused therewith to define a fused empty two-piece hard-shell (FETH) capsule unit having a payload cavity; and
c. a fill hole defined on a center of a dome of the cap portion or body portion and in communication with the payload cavity.

2. The device of claim 1 wherein the elongate body portion includes a first locking groove defined thereon and the cap portion includes a second locking grove defined thereon that is complementary to the first locking groove, and wherein the first locking groove is mated with the second locking groove.

3. A method of filling a two-piece telescoping hard capsule comprising a body portion and a cap portion with a liquid, the method comprising the steps of:
a. providing a fill hole on a center of a dome of either the cap portion or the body portion of a hard shell capsule;
b. fusing the cap portion to the body portion to provide a fused empty two-piece hard-shell (FETH) capsule unit;
c. orienting the FETH capsule such that the fill hole is on top;
d. dispensing the liquid into the FETH capsule unit from a nozzle inserted into the fill hole; and
e. sealing the fill hole after the nozzle is removed.

4. The method of claim 3, wherein the step of fusing the cap portion to the body portion to provide a FETH capsule unit comprises applying a fusing solution to a first locking groove of the body portion, telescoping the body portion into the cap portion into a locking position, and quick drying of the fusing solution.

5. The method of claim 3, wherein the step of sealing the fill hole comprises dripping a droplet of a sealing solution on the fill hole followed by quick drying of the one droplet.

6. The method of claim 5, wherein the quick drying is performed by the application of one or more of heat, dried air, infrared radiation, microwave radiation, and ultrasound radiation to the one droplet.

7. The method of claim 5, wherein the sealing solution comprises:
a. at least one solvent selected from one or more of water and lipophobic solvent;
b. at least one film forming agent selected from one or more of gelatin, starch or its derivatives, cellulose or its derivatives, pullulan or its derivatives, PVA, and gums;
c. at least one rheology modifiers selected from one or more of
i. cellulose derivatives,
ii. starch or its derivatives, and
iii. gums selected from one or more of guar gum, gum arabic, xanthan gum, alginates, carrageenan and gellan gum;
d. an optional wetting agent;
e. plasticizers, coloring agent, release modifying agents, enteric coating material and surfactants as deemed necessary to match the original composition of FETH capsule; and
f. an optional gliding agent.

8. The method of claim 7, wherein the sealing solution composition is adjusted such that:
a. the sealing solution has a viscosity at operating temperature between 500-2500 CP/M⁻¹S⁻¹, and the percentage of water ≤95%;
b. the sealing solution has a contact angle of the one droplet with the FETH capsule surface is in the range of 10°-45°;
c. the sealing solution has a contact angle of the one droplet with the liquid in the FETH capsule is in the range of 140°-180°; and
d. the droplet formed under surface tension has a diameter at its largest point at least 30% larger than a diameter of the filling hole.

9. The method of claim 8, wherein the percentage of water ≤80%.

10. The method of claim 7, wherein the coloring agents comprises at least one of azo-, quinophthalone-, triphenylmethane, xanthene- or indigoid dyes, iron oxides or hydroxides, titanium dioxide, natural dyes, and combinations thereof, to be in a range from about 0.001 percent to about 2 percent based upon the weight of the solution.

11. The method of claim 7, wherein the enteric coating agent comprises at least one of HPMC Acetate Succinate, HPMC Phthalate, Cellulose Acetate Phthalate, PVA Phthalate, methacrylates, and combination thereof, to be in the range from about 0.1 percent to about 30 percent based upon the weight of the solution.

12. A method of producing a hard capsule unit for accepting a liquid payload for pharmaceutical or nutraceutical use, the method comprising:
a. providing a fill hole on a center of a dome of either the cap portion or the body portion of the FETH capsule;
b. obtaining a closed unit of a two-piece telescoping hard capsule comprising a cap portion telescoped onto a body portion; and
c. fusing the cap portion to the body portion to provide a fused empty two-piece hard-shell (FETH) capsule unit.

13. The method of claim 12, wherein the step of providing a fill hole comprises forming the fill hole with a FETH capsule pin bar during an automatic dipping cycle in the manufacture of the cap.

14. The method of claim 13, where the FETH capsule pin bar comprise of a regular dipping pin bar with an extension on the tip that is 10-30%, preferably 20% of the diameter of the dipping pin bar, for the purpose of forming the filling hole during dipping manufacturing process of capsule.
